(19) United States
(12) Patent Application Publication
(10) Pub. No.: US 2010/0070913 A1
(43) Pub. Date: Mar. 18, 2010

(54) SELECTING AN ITEM OF CONTENT IN A GRAPHICAL USER INTERFACE FOR A PORTABLE COMPUTING DEVICE

(75) Inventors: Martin James Murrett, Portland, OR (US); Christopher E. Rudolph, Camas, WA (US); Richard Charles Cave, Camas, WA (US); Kevin Raemon Glyn Smyth, Vancouver (CA)

Correspondence Address: PVF -- APPLE INC.;c/o PARK, VAUGHAN & FLEMING LLP, 2820 FIFTH STREET, DAVIS, CA, 95618-7759, US

(73) Assignee: APPLE INC., Cupertino, CA (US)

(21) Appl. No.: 12/210,764

(22) Filed: Sep. 15, 2008

(51) Int. Cl. G06F 3/048

(52) U.S. Cl. 715/786; 715/802

(57) ABSTRACT

One embodiment of the present invention provides a system that facilitates selecting items of content in a graphical user interface (GUI) for a portable computing device. During operation, the system receives an indication that the portable computing device has been rotated. In response to the rotation, the system presents the user with a detailed list of items of content. Next, the system receives a command from the user to set a focus of the GUI to an item of content in the list. In response to the command, the system shifts the focus to the item of content. Next, the system receives an indication that the portable computing device has been rotated back toward an original orientation. In response to the rotation back, the system selects the item of content.

### BACKGROUND

1. Field of the Invention

The present invention relates to portable computing devices. More specifically, embodiments of the present invention relate to a method and an apparatus for selecting an item of content in a graphical user interface for a portable computing device.

2. Related Art

In recent years, portable computing devices, such as smart phones and personal digital assistants, have rapidly increased in capability and functionality. In fact, some of the latest-generation portable computing devices have more computing power and functionality than their desktop counterparts from just a few years ago. However, these portable computing devices remain resource-constrained in a number of key areas.

For example, many portable computing devices have very small display screens, typically no larger than a couple of inches in either dimension. Note that in order to maintain portability, the display screen has to remain small. If the display screen, and subsequently the portable computing device, is made too large, users will typically forgo the device in lieu of one that is more compact.

Because the size of these portable computing devices is limited, many developers try to maximize the size of the display to cover most of the device, which reduces the area of the device available for input devices and other features. Hence, developers have recently incorporated touch-screens in these devices to make up for the lack of traditional input devices.

One challenge that results from using a small display for both input and visual output is to design an associated graphical user interface (GUI) that is both intuitive and informative. Since portable applications typically do not have the extensive navigation controls found in many of their corresponding desktop and web applications, navigating through a large amount of content on these portable computing devices can be a very cumbersome process.

Hence, what is needed is an improved method for navigating and selecting content on a portable computing device without the problems described above.

### SUMMARY

One embodiment of the present invention provides a system that facilitates selecting items of content in a graphical user interface (GUI) for a portable computing device. During operation, the system receives an indication that the portable computing device has been rotated. In response to the rotation, the system presents the user with a detailed list of items of content. Next, the system receives a command from the user to set a focus of the GUI to an item of content in the list. In response to the command, the system shifts the focus to the item of content. Next, the system receives an indication that the portable computing device has been rotated back toward an original orientation. In response to the rotation back, the system selects the item of content.

In some embodiments of the present invention, the system sorts the detailed list of items. Depending on the desired implementation, the detailed list can be sorted by one of: a time related to the items, an author of the items, a subject of the items, or a type of the items.

In some embodiments of the present invention, the system displays a scrollbar beside the detailed list of items. The system also displays on the scrollbar a position of an item of content that has the focus.

In some embodiments of the present invention, the system receives from the user a pinch gesture on the scrollbar. In response to the pinch gesture, the system adjusts a number of items currently displayed in the detailed list of items.

In some embodiments of the present invention, the system receives from the user a pinch gesture on the scrollbar. In response to the pinch gesture, the system adjusts a density of the content indicators on the scrollbar.

In some embodiments of the present invention, the system receives from the user a touch gesture on the scrollbar. In response to the touch gesture, the system shifts the focus to an item in the detailed list of items most closely related to a location of the touch gesture on the scrollbar.

In some embodiments of the present invention, the original orientation of the portable computing device is a portrait orientation, and the orientation of the portable computing device after the rotation is a landscape orientation, while in other embodiments of the present invention, the original orientation of the portable computing device is a landscape orientation, and the orientation of the portable computing device after the rotation is a portrait orientation.

In some embodiments of the present invention, the portable computing device is rotated around an axis perpendicular to a plane of a display on the portable computing device.

In some embodiments of the present invention, the detailed list of items displays more detail for each item of content than a less-detailed list of items that is displayed to the user in the original orientation.

### BRIEF DESCRIPTION OF THE FIGURES

FIG. 1 illustrates a computing environment in accordance with an embodiment of the present invention.

FIG. 2 illustrates an apparatus in accordance with an embodiment of the present invention.

FIG. 3 presents a flow chart illustrating the process of selecting content on a portable computing device in accordance with an embodiment of the present invention.

FIGS. 4A and 4B illustrate a traditional content-selection process on a portable computing device in accordance with an embodiment of the present invention.

FIGS. 4C-4E illustrate an improved content-selection process on a portable computing device in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system that facilitates selecting items of content in a graphical user interface (GUI) for a portable computing device. During operation, the system receives an indication that the portable computing device has been rotated. In response to the rotation, the system presents the user with a detailed list of items of content. Next, the system receives a command from the user to set a focus of the GUI to an item of content in the list. In response to the command, the system shifts the focus to the item of content. Next, the system receives an indication that the portable computing device has been rotated back toward an original orientation. In response to the rotation back, the system selects the item of content.

Note that the portable device does not need to be rotated precisely to a certain orientation, but can be within some degree of tolerance of the desired orientation. Furthermore, note that in some embodiments of the present invention, the device does not need to be rotated back toward the original orientation to make the selection, but instead may be rotated further in the same direction to an orientation that is approximately 180 degrees from the original orientation.

For example, if the original orientation is a portrait orientation and the portable computing device is right side-up, the user may rotate the device clockwise approximately 90 degrees to access the detailed list. Once the user moves the focus to the desired content, the user may rotate the device either clockwise or counterclockwise approximately 90 degrees to make the selection. In some instances, the portable computing device might end up in a portrait orientation that is approximately 180 degrees offset from the original orientation, wherein the portable computing device is upside-down.

Also note that the portable computing device comprises some mechanism that enables the portable computing device to determine its orientation and movement. Note that this can be accomplished many different ways, including accelerometers, gyros, analyzing camera input, etc.

In some embodiments of the present invention, the system sorts the detailed list of items. Depending on the desired implementation, the detailed list of items can be sorted by one of: a time related to the items, an author of the items, a subject of the items, or a type of the items. Note that these sorting criteria are listed for exemplary purpose only, and the present invention is not meant to be limited to these sorting criteria. Moreover, the criteria for sorting content may be application-specific, and may include user-configurable options.

In some embodiments of the present invention, the system displays a scrollbar beside the detailed list of items. The system also displays on the scrollbar a position of an item of content that has the focus.

In some embodiments of the present invention, the system receives from the user a pinch gesture on the scrollbar. In response to the pinch gesture, the system adjusts a number of items currently displayed in the detailed list of items. For example, if the user pinches his or her fingers together, the system may display less content to the user. In contrast, if the user spreads his or her fingers apart on the scrollbar, the system may display more content to the user.

In some embodiments of the present invention, the system receives from the user a touch gesture on the scrollbar. In response to the touch gesture, the system shifts the focus to an item in the detailed list of items most closely related to a location of the touch gesture on the scrollbar. In some embodiments of the present invention, it may be useful for a user to scroll through the content by manipulating the content itself when the user is close to the desired content that he or she is looking for. However, if the user is a long way off from the desired content, the user may wish to use the scrollbar to quickly navigate to the area of the desired content.

In some embodiments of the present invention, the original orientation of the portable computing device is a portrait orientation, and the orientation of the portable computing device after the rotation is a landscape orientation. However, note that many different orientations can be used for different navigation techniques. For example, some embodiments of the present invention might use eight different orientations that are approximately 45 degrees offset from each other. Also note that any orientation can be the default or primary orientation. For example, in some embodiments of the present invention, the original orientation of the portable computing device is a landscape orientation, and the orientation of the portable computing device after the rotation is a portrait orientation

In some embodiments of the present invention, the portable computing device is rotated around an axis perpendicular to a plane of a display on the portable computing device. Note that while the use of rotation and manipulation in two dimensions is discussed herein, embodiments of the present invention may similarly make use of manipulation of the portable computing device in three dimensions, including any of the possible translational and/or rotational degrees of freedom.

In some embodiments of the present invention, the detailed list of items displays more detail for each item of content than a less-detailed list of items that is displayed to the user in the original orientation. For example, the original orientation might display a simple list of posts by different users that indicates only the identity of the poster and the time of the post, while the detailed list might include all of the details of each post.

### Computing Environment

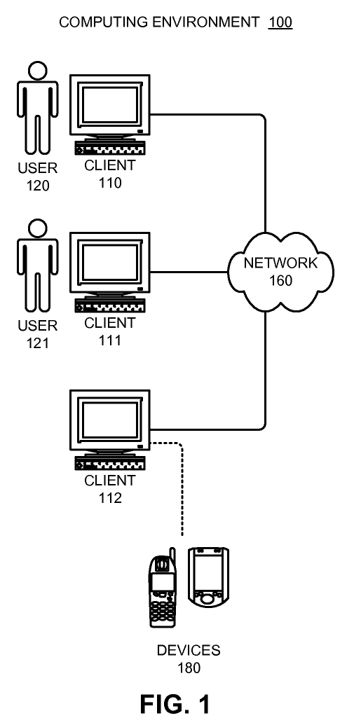

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, network 160, and devices 180.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Devices 180 can include any type of electronic device that can be coupled to a client, such as client 112. This includes, but is not limited to, cell phones, personal digital assistants (PDAs), smart-phones, personal music players (such as MP3 players), gaming systems, digital cameras, portable storage media, or any other device that can be coupled to the client. Note that in some embodiments of the present invention, devices 180 can be coupled directly to network 160 and can function in the same manner as clients 110-112.

Note that different embodiments of the present invention may use different system configurations, and are not limited to the system configuration illustrated in computing environment 100.

### Apparatus

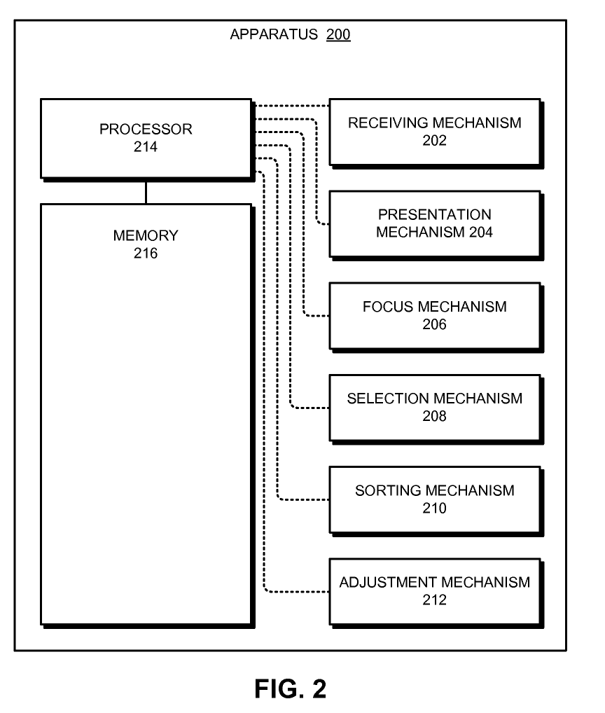

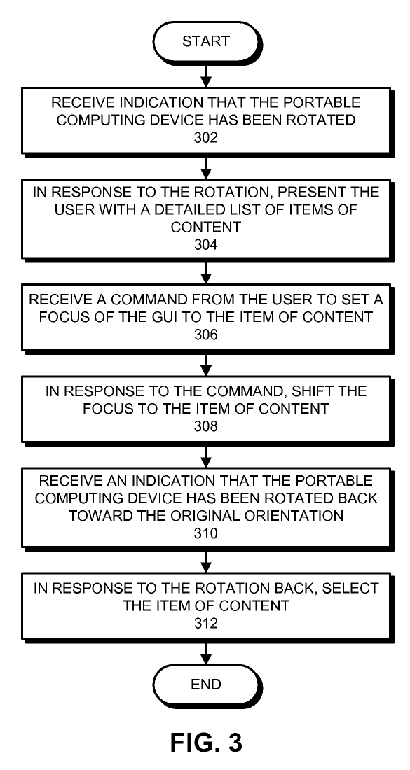

FIG. 2 illustrates an apparatus 200 in accordance with an embodiment of the present invention, and FIG. 3 presents an associated flow chart illustrating the process of selecting content on a portable computing device in accordance with an embodiment of the present invention.

Apparatus 200, which can comprise portable computing device 400, includes receiving mechanism 202, presentation mechanism 204, focus mechanism 206, selection mechanism 208, sorting mechanism 210, adjustment mechanism 212, processor 214, and memory 216.

### Content-Selection Process

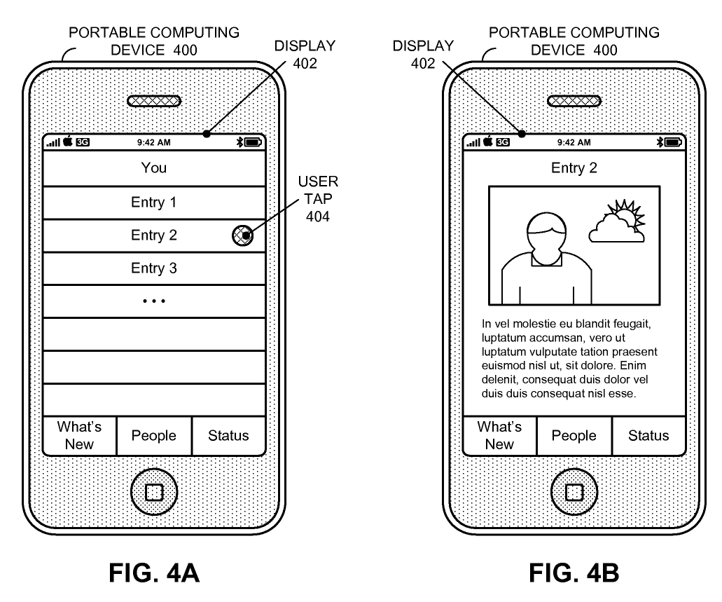

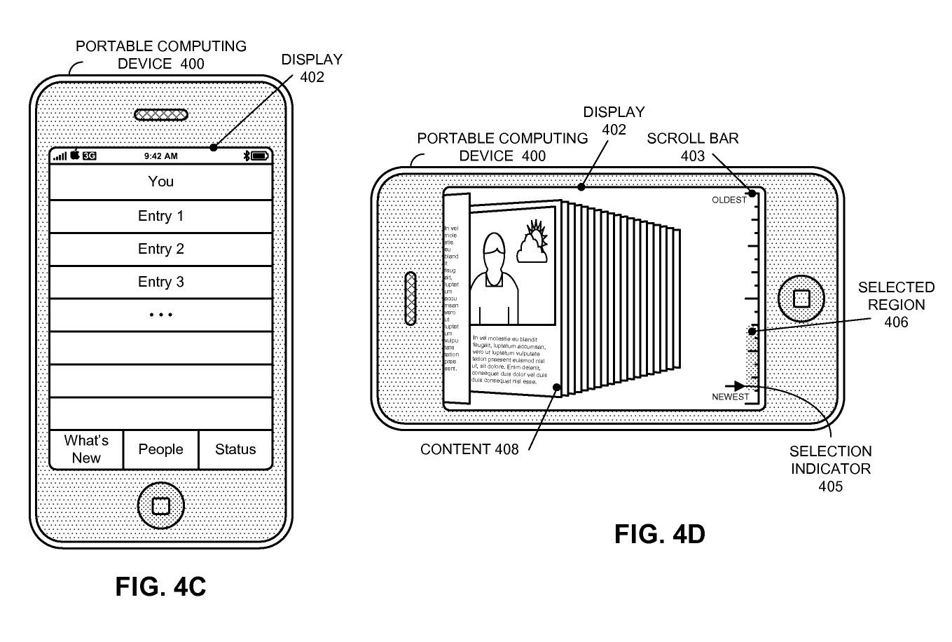

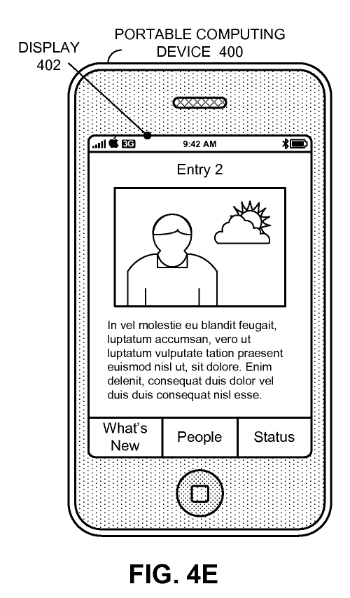

FIGS. 4A and 4B illustrate a traditional content-selection process on portable computing device 400 in accordance with an embodiment of the present invention. FIGS. 4C-4E illustrate an improved content-selection process on portable computing device 400 in accordance with an embodiment of the present invention. Note that FIGS. 4C-4E illustrate a different technique for selecting the same item of content as FIGS. 4A and 4B.

Note that the embodiments disclosed herein refer to a social-networking application for exemplary purposes. However, embodiments of the present invention are not meant to be limited to social-networking applications.

In a traditional selection environment for a typical social-networking application, a user 120 is presented with a simple list of entries for various users, as is shown on display 402 of portable computing device 400 in FIG. 4A. User 120 then taps the entry that he or she wishes to view, as illustrated by user tap 404. In response to this user tap, the system displays the detailed entry that the user selected with user tap 404, as illustrated in FIG. 4B.

Embodiments of the present invention provide an improved method of navigating and selecting beyond the traditional process described above. In one embodiment of the present invention, during operation, receiving mechanism 202 receives an indication that the portable computing device 400 has been rotated (operation 302). Consider the example where portable computing device 400's initial orientation is as shown in FIG. 4C. User 120 then rotates portable computing device 400 to the orientation shown in FIG. 4D. In response to the rotation, presentation mechanism 204 presents user 120 with a detailed list of items of content (operation 304).

Next, receiving mechanism 202 receives a command from user 120 to set a focus of the GUI to the item of content (operation 306). In response to the command, focus mechanism 206 shifts the focus to the item of content (operation 308). Note that the focus can be indicated in one or more ways, using any one of a number of known techniques for different embodiments. As pictured in FIG. 4D, the focus is indicated by the item of content that is most prominently displayed in display 402, namely content 408.

In some embodiments of the present invention, the content is stacked along a simulated Z-axis, which user 120 can navigate by moving his or her finger along a vector collinear to the simulated Z-axis.

Receiving mechanism 202 then receives an indication that the portable computing device 400 has been rotated back toward an original orientation (operation 310) by user 120, as illustrated in FIG. 4E. Finally, in response to the rotation back, selection mechanism 208 selects the item of content (operation 312) which is most prominently displayed on display 402.

In some embodiments of the present invention, sorting mechanism 210 sorts the detailed list of items. Depending on the desired implementation, the detailed list of items can be sorted by one of: a time related to the items, an author of the items, a subject of the items, or a type of the items. Note that as described previously, options related to sorting criteria can be configurable by user 120 or by a system administrator.

In some embodiments of the present invention, presentation mechanism 204 displays scrollbar 403 beside the detailed list of items, as illustrated in FIG. 4D. The system also displays on the scrollbar a position of an item of content that has the focus, as is indicated by selection indicator 405. Furthermore, the system may indicate on the scrollbar a selected region 406, which indicates the range of all of the items visible on display 402 at the current time. Note that while in FIG. 4D only content 408 and part of one other item of content which is newer than content 408 is visible, in other embodiments, user 120 can see a portion of all of the items of content currently displayed on display 402.

In some embodiments of the present invention, receiving mechanism 202 receives from the user a pinch gesture on the scrollbar. In response to the pinch gesture, adjustment mechanism 212 adjusts a number of items currently displayed in the detailed list of items.

### CONCLUSION

Embodiments of the present invention relate to a method and an apparatus for selecting an item of content in a graphical user interface for a portable computing device by rotating the portable computing device. In a traditional portable computing device, a simple list of items is displayed to a user, and the user navigates through the items by selecting an item, and then pressing the “back” button to return to the simple list. If the user wants to find an item in the list, but is not sure which item he or she is looking for, the user might review a dozen or more items by selecting individual items from the simple list, and selecting back after each item.

In contrast to the simple list method of navigating content, embodiments of the present invention provide an easier technique for browsing and selecting content. At any time, the user can rotate the portable computing device to view a detailed list view that displays the content of each item in a way that allows the user to quickly flip through the items to find the desired item. Once the focus is on the desired item, the user simply rotates the portable computing device to select the desired item. By using rotation as a selection tool, a user can simply rotate the portable computing device to view the list, browse to the desired item, and then rotate the portable computing device to make the selection, thus eliminating the need to constantly select an item, hit the back button, and select another item in search of the desired item.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for selecting an item of content in a graphical user interface (GUI) for a portable computing device, the method comprising:
receiving an indication that the portable computing device has been rotated;
in response to the rotation, presenting the user with a detailed list of items of content;
receiving a command from the user to set a focus of the GUI to the item of content;
in response to the command, shifting the focus to the item of content;
receiving an indication that the portable computing device has been rotated back toward an original orientation; and
in response to the rotation back, selecting the item of content.

2. The method of claim 1, further comprising sorting the detailed list of items, wherein the detailed list of items can be sorted by one of:
a time related to the items,
an author of the items,
a subject of the items, and
a type of the items.

3. The method of claim 1, further comprising:
displaying a scrollbar beside the detailed list of items; and
displaying on the scrollbar a position of an item of content that has the focus.

4. The method of claim 3, further comprising:
receiving from the user a pinch gesture on the scrollbar; and
in response to the pinch gesture, adjusting a number of items currently displayed in the detailed list of items.

5. The method of claim 3, further comprising:
receiving from the user a touch gesture on the scrollbar; and
in response to the touch gesture, shifting the focus to an item in the detailed list of items most closely related to a location of the touch gesture on the scrollbar.

6. The method of claim 1, wherein the original orientation of the portable computing device is a portrait orientation, and wherein the orientation of the portable computing device after the rotation is a landscape orientation.

7. The method of claim 1, wherein the portable computing device is rotated around an axis perpendicular to a plane of a display on the portable computing device.

8. The method of claim 1, wherein the detailed list of items displays more detail for each item of content than a list of items that is displayed to the user in the original orientation.

9. A computer-readable storage medium storing instructions that when executed by a computer cause the computer to perform a method for selecting an item of content in a graphical user interface (GUI) for a portable computing device, the method comprising:
receiving an indication that the portable computing device has been rotated;
in response to the rotation, presenting the user with a detailed list of items of content;
receiving a command from the user to set a focus of the GUI to the item of content;
in response to the command, shifting the focus to the item of content;
receiving an indication that the portable computing device has been rotated back toward an original orientation; and
in response to the rotation back, selecting the item of content.

10. The computer-readable storage medium of claim 9, wherein the method further comprises sorting the detailed list of items, wherein the detailed list of items can be sorted by one of:
a time related to the items,
an author of the items,
a subject of the items, and
a type of the items.

11. The computer-readable storage medium of claim 9, wherein the method further comprises:
displaying a scrollbar beside the detailed list of items; and
displaying on the scrollbar a position of an item of content that has the focus.

12. The computer-readable storage medium of claim 11, wherein the method further comprises:
receiving from the user a pinch gesture on the scrollbar; and
in response to the pinch gesture, adjusting a number of items currently displayed in the detailed list of items.

13. The computer-readable storage medium of claim 11, wherein the method further comprises:
receiving from the user a touch gesture on the scrollbar; and
in response to the touch gesture, shifting the focus to an item in the detailed list of items most closely related to a location of the touch gesture on the scrollbar.

14. The computer-readable storage medium of claim 9, wherein the original orientation of the portable computing device is a portrait orientation, and wherein the orientation of the portable computing device after the rotation is a landscape orientation.

15. The computer-readable storage medium of claim 9, wherein the portable computing device is rotated around an axis perpendicular to a plane of a display on the portable computing device.

16. The computer-readable storage medium of claim 9, wherein the detailed list of items displays more detail for each item of content than a list of items that is displayed to the user in the original orientation.

17. An apparatus configured for selecting an item of content in a graphical user interface (GUI) for a portable computing device, comprising:
a receiving mechanism configured to receive an indication that the portable computing device has been rotated;
a presentation mechanism configured to present the user with a detailed list of items of content in response to the rotation;
wherein the receiving mechanism is further configured to receive a command from the user to set a focus of the GUI to the item of content;
a focus mechanism configured to shift the focus to the item of content in response to the command;
wherein the receiving mechanism is further configured to receive an indication that the portable computing device has been rotated back toward an original orientation; and
a selection mechanism configured to select the item of content in response to the rotation back.

18. The apparatus of claim 17, further comprising a sorting mechanism configured to sort the detailed list of items, wherein the detailed list of items can be sorted by one of:
a time related to the items,
an author of the items,
a subject of the items, and
a type of the items.

19. The apparatus of claim 17:
wherein the presentation mechanism is further configured to display a scrollbar beside the detailed list of items; and
wherein the presentation mechanism is further configured to display on the scrollbar a position of an item of content that has the focus.

20. The apparatus of claim 19, wherein the receiving mechanism is further configured to receive from the user a pinch gesture on the scrollbar, and wherein the apparatus further comprises an adjustment mechanism configured to adjust a number of items currently displayed in the detailed list of items in response to the pinch gesture.
